(19) United States
(12) Patent Application Publication
(10) Pub. No.: US 2006/0253702 A1
(43) Pub. Date: Nov. 9, 2006

(54) Secure gaming server

(75) Inventors: Mark Lowell, Reno, NV (US); Stephen Patton, Reno, NV (US); Michael Wilhelm Hartman, Reno, NV (US)

Correspondence Address: SIERRA PATENT GROUP, LTD., 1657 Hwy 395, Suite 202, Minden, NV, 89423, US

(73) Assignee: GameTech International, Inc.

(21) Appl. No.: 11/269,134

(22) Filed: Nov. 7, 2005

Related U.S. Application Data
(60) Provisional application No. 60/632,435, filed on Nov. 30, 2004.

(51) Int. Cl. G06F 15/16; H04L 9/00; G06F 17/00; G06F 9/00

(52) U.S. Cl. 713/156; 713/175; 713/181; 713/172; 726/11

(57) ABSTRACT

A method and apparatus for authenticating equipment and software in a distributed gaming environment through the use of embedded, digital keys and digital certificates in a private key infrastructure (PKI) is disclosed. By issuing a key from a trusted root server, authentication is performed in a serial manner throughout the operational chain of hardware and/or software modules that collectively serve to support the gaming environment. Beginning with the root certificate authority server, each module in the operational chain authenticates itself to another module that relies on that module's authenticity. By authenticating the chain of modules in a serial manner from beginning to end, security of the gaming environment is ensured.

### RELATED APPLICATION

This patent application claims priority to Provisional Patent Application No. 60/632,435, entitled UNIVERSAL GAMING DEVICE, filed Nov. 30, 2004, which is copending, herein incorporated by reference in its entirety.

### FIELD

The present invention relates broadly to computer systems supporting gambling operations. Specifically, the present invention relates to a secure computer system that supports gaming applications through various modules that are verified by a trusted source.

### BACKGROUND

Gaming environments have become increasingly reliant on automated systems, such as hardware and software, to administer functions and processes that support the gaming environment. However, as these gaming environments involve the exchange of money, security of the underlying functions and processes has become a primary concern, and safeguards must be in place before operators of the gaming environment are licensed by their respective gaming authorities.

Because the gaming environments now are dispersed over wide geographic areas and involve hardware and software that communicates with remotely located sites, there is an inherent opportunity for security breaches to occur within the communication path between sites, thus providing cheats with a way to control game outcome and reap illegal profits. This problem is especially difficult to solve because the gaming environment often involves a chain of communication across multiple computers that together serve to support the gaming environment.

### SUMMARY

The present invention solves the problems described above by authenticating key equipment and software in a distributed gaming environment through the use of embedded, digital keys and digital certificates in a private key infrastructure (PKI). By issuing a key from a trusted source, referred to herein as the root server, authentication is performed in a serial manner throughout the operational chain of hardware and/or software modules that collectively serve to support the gaming environment. Beginning with the root certificate authority server, each module in the operational chain authenticates itself to another module that relies on that module's authenticity. By authenticating the chain of modules in a serial manner from beginning to end, security of the gaming environment is ensured.

In one aspect, the present invention provides a secure, server-based gambling system. The system includes a root digital certificate created by a trusted source that indicates authenticity of a server platform for a networked gambling system by authenticating software and data residing on the server platform. In an embodiment, the root digital certificate comprises a public key and a private key. In an embodiment, the public key and private key are stored together in a token. Depending on the embodiment, the token can be a magnetic storage device, an optical storage device, and can be configured to be a read-only storage device. In an embodiment, the root certificate authority utilizes a Federal Information Processing Standards (FIPS) Level 3 Certified Hardware Security Module configured to generate a public key and a private key.

The system also includes a gaming certificate authority server (gaming CA) and a gaming registration authority server (gaming RA). In an embodiment, a firewall separates the gaming certificate authority from the gaming registration authority. The gaming CA is configured to issue digital certificates to the gaming RA. The gaming RA is configured to receive certificate requests from clients, authenticate the requesting clients, and transmit certificate requests made by the authenticated clients to the gaming CA. The gaming RA is configured to receive digital certificates from the gaming CA and transmit them to authenticated clients. In an embodiment, the client includes a user certificate authority, which can include a signing station. The client utilizes a process that offers a user certificate as authentication of a user. In an embodiment, functionality of the gaming RA is incorporated into the gaming CA.

In another aspect, the present invention provides a method of operating a server-based gambling system, comprising the acts of issuing a root digital certificate from a trusted source to a gaming certificate server; authenticating a gaming CA by examining a private key and public key associated with the gaming CA and generating a second digital certificate indicating that the gaming CA is authentic, the second digital certificate containing data indicating the root digital certificate; the gaming CA authenticating a user certificate authority server that is located at a user site and generating a third digital certificate, the third user certificate containing data indicating the second digital certificate; and transmitting and receiving data sets and key values to and from clients authenticated by the user certificate authority server at the user site.

In an embodiment, after a unique public and private key pair is generated, the public key is registered with a gaming RA with a request for a certificate that certifies that the public key belongs to the user. The root certificate authority (root CA) server is used to create the gaming CA. Like the Gaming CA, the root CA has a public and private key pair with the private key residing on the root token and the public key residing on the certificate request machine. The public key is used by root certificate authority when issuing, managing and revoking certificates to the gaming CA.

In an embodiment, a hardware security module (HSM) is included in the present invention. When necessary, a token is read by the HSM. In an embodiment, the HSM is an electronic card reader that is physically wired to the certificate request machine and later transferred to the signing station (after creation of the root CA and gaming CA). When the system is looking for the root private key to create the gaming CA, it is directed to the HSM. If the token is in the reader and the reader has been unlocked using PED keys and PINs, the system has access to the root private key and can generate a gaming certificate. If the token is not physically present in the HSM or has not been physically unlocked using the PED keys and PINs, the system cannot find the root private key and will not function to create the gaming CA.

When the security token is inserted into the HSM, it is still not functional until the HSM is physically unlocked. In an embodiment, there are three individually-issued security officer keys that are required to unlock the HSM and allow the root private key to function. These three keys are PED keys, not digital keys created by the software, but physical keys requiring PINs (4-16 digits) to unlock the HSM which stores the root private key.

The root CA is at the top of the PKI hierarchy of the present invention and is the most critical entity within the system of the present invention. In an embodiment, to minimize the risk of a security compromise, the root CA only issues, manages and revokes certificates to the gaming CA. This self-signed root certificate is embedded in software and disk-on-modules and authenticates software on various servers and devices. There is only one root CA, and, if compromised, everything within the PKI structure is compromised. Therefore, protecting the integrity of the root CA is imperative, as all applications in the system of the present invention look for authentication when started. The root CA uses the HSM to generate a digital root private and public key pair. The private key is stored in the HSM tamper proof token at all times. It is generated using its own random number generator. The public key is downloaded from a local web interface and, in an embodiment, stored on a certificate request machine. The root CA requires the root private key to be used to generate a root certificate. Without the root private key, a certificate cannot be created, so protecting the root private key is essential. If the root private key is compromised, it can generate a genuine root certificate that can be ultimately embedded in an unauthorized version of software. Once a false gaming certificate is created, a false application can be created and the system is compromised. The root private key on the HSM token is used locally for the authentication process while a second token is stored off-site in a secure location.

The next item in the PKI hierarchy is the gaming CA. The gaming CA is subordinate to the root CA and is created using the root CA private key on the HSM token. The gaming CA handles the day-to-day operations of issuing, managing and revoking certificates to the individual bingo operations and creates digital authentication for executables. The gaming CA must have a valid certificate from the root CA for its private and public key pairs to function. The private key of the gaming CA is stored in a separate token from the root CA token. As the final step for delivering software to the field, the gaming CA will sign the software as authentic and create a digital authentication of the executables using its own private key whose corresponding public key is managed by the root CA via digital certificate. When the software is installed in a gaming operation, the system will verify the digital authentication of the executables with the public key of the attached gaming CA certificate. Before authentication however, the system alsalso validates the gaming CA certificate with the embedded root certificate via certificate chaining. As with the root CA, the gaming CA also creates a public and private key pair. In an embodiment, the public key is contained in a certificate file that is transferred to the signing station machine from the certificate request machine. The gaming CA's private key resides on a gaming CA (HSM) token, which is a separate token from that storing the root CA's private key.

In an embodiment, the generation of a gaming CA is a two step process. The first step involves generating a request from the signing station. The second is processing a request from the certificate request machine.

It is important to understand that there is a physical location where the authentication process takes place. Using the simple online shopping example, authentication activity takes place at the source or local PC. The local PC and peripheral connections make up the PKI perimeter. In an embodiment, the PKI perimeter is the signing station. It is important to understand the PKI perimeter as that is the area that is vulnerable to intrusion and must be secured.

The signing station resides in the central office and is used to sign system, device, and peripheral programs and data sets. In an embodiment, signing occurs by encryption of a hash value created from the program and data sets. Encryption is performed using the gaming CA's private key. The encrypted hash value and gaming certificate are attached to the end of the program or main data set. In an embodiment, the program or data set is authenticated by the secure boot loader. However, in alternative embodiments, authentication can be performed by other resources within a server or device. Likewise, software and datasets are authenticated before they are installed and/or loaded.

The certification authority server resides on the certificate request machine and is used to revoke a certificate, download a certificate revocation list (CRL), and view revoked certificates, issued certificates, pending certificate requests and failed certificates.

In embodiments of the present invention, a hardware device referred to herein as the boot loader replaces the conventional hard disk drive on server machines in the PKI infrastructure as the boot device. Once installed, this device blocks users from accessing specific commands. By blocking these specific commands, the user is prevented from making unauthorized changes to the system.

Other features and advantages of the present invention will become apparent from the following detailed description, when considered in conjunction with the drawings, in which:

### BRIEF DESCRIPTION OF THE DRAWINGS

FIG. 1 illustrates components of the present invention maintained at a central office.

FIG. 2 illustrates components of the present invention maintained at a gaming site.

### DETAILED DESCRIPTION

Digital certificates are used throughout embodiments of the present invention and in different forms. For example, a data set signed digital certificate is issued by the gaming certificate authority based signing station. The certificate includes a serial number, expiration date, encrypted data set hash, encrypted digital certificate hash, and the gaming certificate authority's digital public key. Examples of data sets include game executables, game graphics, game setup programs, game configuration data, and gambling machine peripheral programs such as bill acceptor executables.

A user digital certificate is an electronic identification card that establishes a server, service, gambling device, peripheral such as a bill acceptor, or system user such as a technician credentials for identification as a legitimate user for secure transactions. The certificate contains information such as the gambling device name or ID, bill acceptor name or ID, user name or ID, a serial number, expiration date, a copy of the user's public key (used for encrypting messages and digital signatures), and the digital signature of the certificate-issuing authority. Digital certificates in accordance with embodiments of the present invention comply with the X.509 standard. These certificates contain information such as the version number, serial number, validity date, and subject's public key. The certificate contains both the certificate information and the digital signature of the signing certificate authority (signing CA). The signature is the signing CA's private key encrypted hashed value of the certification information. Digital certificates can be kept in registries so that authenticating machine can look up other machine's public keys.

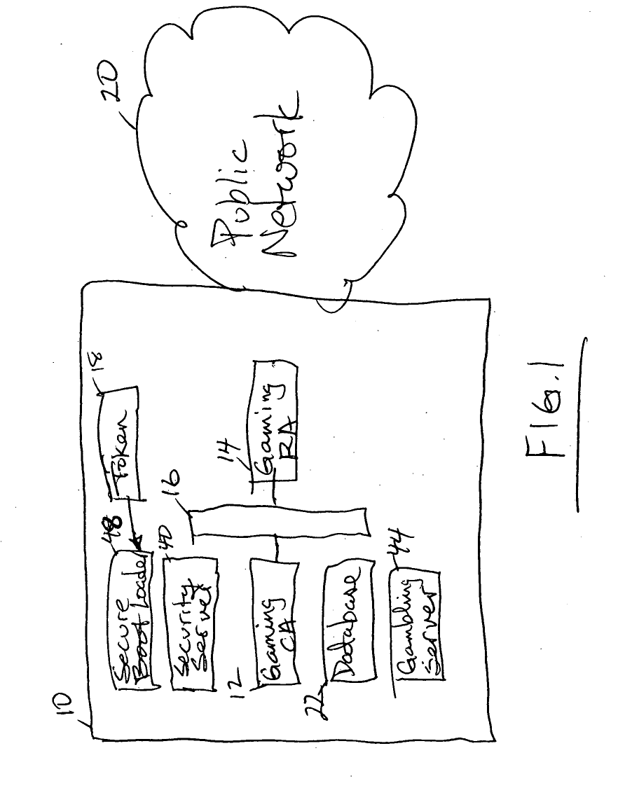

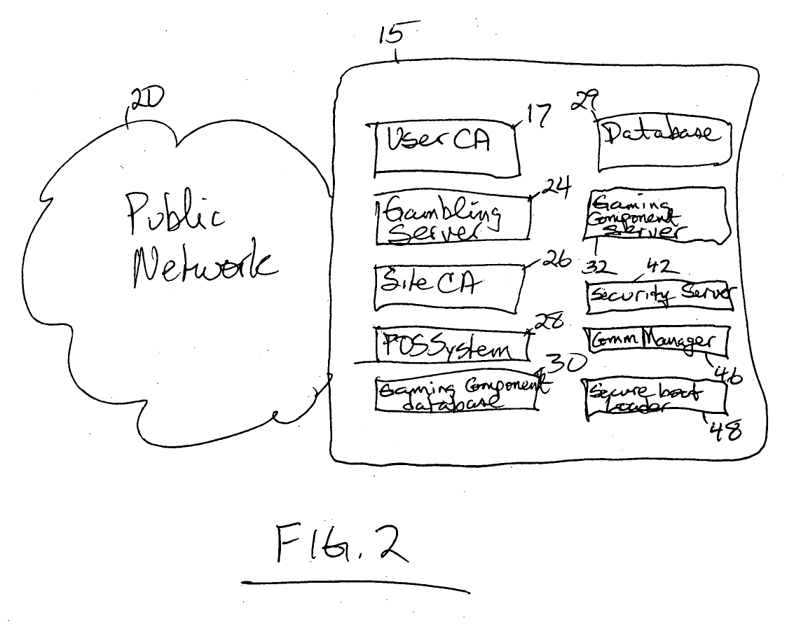

There are several preferred configurations of the present invention. Directing attention to FIGS. 1 and 2, central office 10 incorporates gaming CA 12 and gaming RA 14 separated by communication firewall 16. In this embodiment, gaming CA 12 is in communication with an offsite root CA. The root CA is considered a trusted source of verification keys, which are stored on token 18 that is transported to central office 10 by conventional delivery methods such as hand delivery rather than communicated over a communication network. Token 18 is a portable storage device capable of storing data, and can be magnetic storage, optical storage, and the like. Gaming RA 14 is in communication with user CAs (not shown) which can be located at site 15 at managed gaming environments such as casinos, bingo halls, and the like. Gaming RA 14 communicates with one or more user CA 17 by public network 20, such as Internet. While FIG. 1 illustrates gaming CA 12 and gaming RA 14 as separate servers separated by a firewall, in an alternative embodiment, gaming CA 12 can incorporate the functionality of gaming RA 14, and thus firewall 16 would simply separate gaming CA 12 from connection to public network 20.

A site secret is a value that is securely exchanged between the user CA and gaming RA 14 by encrypting it using the user CA's public key extracted from a valid certificate request from a site. In central office 10, the site secrets are stored in secure database 22 for the security server (not shown) to generate and distribute passwords to authorized employees. The issued certificate may include details such as the password change frequency and expiration date. The site secret is a unique 3DES key generated by the gaming CA to authenticate the contents of unprotected hard disk space during the boot-up process by decrypting the 3DES or equivalent key encrypted contents on some implementations. The site secret is stored 3DES encrypted or equivalent by the boot password. The site secret is also used to generate one-time passwords for technicians, accountants, and customer support for accessing the system via a network.

When the user CA receives the new site secret from gaming CA 12, it is encrypted using the user CA's public key so that only the user CA having the corresponding private key may decrypt the site secret. As other clients request certificates from the user CA, the site secret is passed to the client, encrypted using the client's public key. Only the client possessing the corresponding private key may decrypt the site secret. As referred to herein, a client can be any of: a device, a process that communicates with another device, or a user of the device or process.

User CA and client private keys are encrypted using an obfuscated symmetrical key encryption algorithm. User private keys are encrypted using user passwords. The device or peripheral validates gaming CA 12's certificate using the device or peripheral's embedded root certificate. The gaming certificate includes a root public key encrypted hash of the gaming certificate's public key. The validation is accomplished by running a hash on gaming CA 12's public key (and optionally other certificate fields), encrypting the hash using the embedded root certificate, then comparing the derived gaming public key encrypted hash value with the one contained in the gaming certificate. If the values match, the software or dataset is next validated. A hash is run on the software or dataset. The hash result is then encrypted using the gaming certificate's public key. The software or dataset's encrypted hash value is then compared with the encrypted hash value stored by the signing station at the end of the software or dataset. If the values match, the software or dataset is allowed to be installed or loaded. If the values don't match, the software or dataset is not allowed to be installed or loaded.

Embodiments of the present invention utilize the secure socket layer (SSL) protocol to manage the security of a message transmission on public network 20. SSL uses a layer between the application and transport control protocol (TCP) layers. SSL uses the public-and-private key encryption system and digital certificates from both parties for authentication and then exchanges session keys for subsequent bulk encryption.

The session secret is a set of random numbers generated at the beginning of a gaming session. The session secret is used to encrypt RF messages for wireless devices or SSL using the symmetric key cryptography such as 3DES.

The system of the present invention can be classified into two types of components, gaming components (GCs) and site management components (SMCs). Only secured, authenticated devices are allowed in the gaming component.

Example devices in the gaming component are various servers, a caller/verifier, point of sales (POS) systems, self-serve kiosks, fixed-base player units, and portable player units.

Gambling server 24 authenticates all device certificates as either class A or class B based upon the device certificates issued by site CA 26. Class A certificates identify GC devices and class B certificates identify SMC devices. Based upon the certificates, the server establishes SSL connections with the clients and handles appropriate messaging.

Gambling server 24 processes messages that update critical gambling data if and only if the messages come from devices with a class A certificate. No device is allowed to establish SSL connections with gambling server 24 without a valid certificate issued by the user CA.

Gaming components manage the actual game play. On some systems, game play begins with an operator logging into point of sale (POS) system 28. Products sold include electronic bingo cards, paper bingo cards, and entertainment services.

POS system 28 records all game-critical sales data such as sold items, sold bingo card numbers, session numbers, starting values, pack numbers, and VIP player information in the gaming component database 30. Communication between gaming component server 32 or a service and device occur via an SSL connection. A client never writes to a GC database component directly. POS system 28 may record data that is not game-critical such as unsold paper card information and site employee information to database 29 via an SSL connection which has been negotiated with a secured site certificate. On other systems, game play begins when users login or insert cash into a player terminal. Game play and other transactions are stored in the GC database 30.

Site management components include site management software and a site database server(s) for sales analysis, inventory control, player management, and site employee management. The site management system does not affect the actual critical gaming integrity. Site management software can read and write only to the site database server's database that contains non-game-critical data such as unsold card information, player information, site employee information, and the like.

All GC floor devices implement a secure boot loader and digital authentication for program and data set authentication. The secure boot loader ensures that only authentic executables are loaded into memory during the boot process. GC servers are usually located in a locked room. Servers in this environment are usually under the control of an IT staff. Programs that are allowed to run on the GC server may be authenticated by a boot loader or optionally a white list file. The white list file contains programs that may run on the server as well as their hash value. A hash function is run against the program, then matched against its white list hash value before the program is executed. Sensitive gaming data is only accessed by applications running on the server. Non-gaming (GMC) data may be accessed directly by client applications. Client devices must sign critical designated records with their private keys.

The database signature validator is an application on the gambling server that reads through each secured database file and verifies the records using the site public key. If any digital signature of a record does not validate, it flags an error to a technician.

The security server 40 at central office 10 and the security server 42 at site 15 are available via the secured intranet or internet site. Internal applications request current central and remote site passwords from the security server for specific sites. Field technicians log into the security server to request current network and operating field technician account logins/passwords, or passwords for a specific site.

All such requests are logged to provide an audit trail of who had access to which site for which time periods. Access to specific sites is controlled and managed by region and authorization. Notices are proactively sent and logged when technicians request passwords that provide access to critical functions.

SiteCom (not shown) is an application that allows an authorized employee to connect to a central or remote gambling site. When the application connects, it prompts the user for a login name and password. The technician obtains the appropriate site login and password by logging into gambling server 44 at central office 10 or remote secure gambling server 24 at site 15 with his own assigned login name and password. This process may be automated.

After the technician receives the site login name and password from the security service, SiteCom negotiates the site login name and password with gambling site to establish a connection. Based upon the site loginlpassword, the server provides appropriate access to its system resources.

Passwords for site IT accounts, local technician accounts, database accounts, etc., are based on an algorithm seeded by the site secret. These change on a regular, configurable basis. Access to these passwords are controlled and distributed by the corporate IT system.

For some implementations, networked client units are authenticated by periodically changing the client password on the server. The periodically changing of network passwords is based on the site secret, the date, the time, and the password generation frequency.

All devices require a certificate from user CA 17 for authentication. User CA 17 is the service or server that runs on the secure gambling server computer or network that issues, manages, and revokes certificates to all of its client machines within a gambling site.

CommManager 46 is a program that manages the SSL handshakes from clients. CommManager 46 verifies the (user CA issued) client certificates and exchanges the session key for all subsequent messages with the server. The client devices authenticates with a server or service via the certificate issued to user CA 17 by gaming CA 12 or user CA 17 itself.

Employee and player access are controlled via standard user name and password application level security. In an embodiment, an employee or player could be issued a digital certificate.

Secure boot loader 48 is trusted software that verifies the operating system and other executables within the system are authentic when the system boots. Secure boot loader 48, combined in some cases with a custom BIOS, provide the system with a root of trust. For some implementations, secure boot loader 48 is the read-only disk-on-chip that contains an operating system and network operating system. For other implementations, secure boot loader 48 is the secured boot sector within the hard drive that is authenticated by the read-only BIOS.

For some systems, both operating and network operating systems are stored in a read-only disk-on-chip. The read-only disk-on-chip ensures that only authenticated operating systems are loaded when the system boots. The read-only disk-on-chip is considered the root of trust, and contains the root certificate along with the digital authentication application that authenticates all executables on the rewritable hard-disk within the system.

A client device may include a slot terminal with a BIOS, a read-only disk-on-chip, and a re-writable hard drive. In this embodiment, the secure boot loader is a read-only disk-on-chip that contains the operating system, network operating system, the root certificate, and authentication program. The read-only nature of the disk-on-chip ensures that its content is authentic, and provides the basis of the root of trust.

Secure boot loader 48 example relies on a standard personal computer BIOS. The standard BIOS is configured to boot only from secure boot loader 48, and the rewritable hard drive is configured as a non-bootable slave drive. Machines with a secure boot loader are further secured with a combination of tamper resistant tape, security lock, and power off detection devices, so that only authorized technicians may have access to the internals of the machine.

The root certificate is stored in the read-only secure boot loader 48. The authentication program within the boot loader uses the root certificate to verify the digital authentication of new software updates and the certificate(s) issued by gaming CA 12.

To implement token 18, a secure BIOS ROM may be used, such as the Phoenix “FirstBIOS ROM” is a tamper-proof ROM that stores the cold-boot code, a seed of trust, and a hard-coded hash value. It is a removable chip that may be secured with security tape so that a regulatory agent may remove the chip and verify its contents for a security audit at any time. The secured BIOS ROM hash-checks the intermediate bootable service areas and root certificate against the hard coded hash value stored in the secured BIOS ROM to verify its authenticity.

When a gaming server, device, or peripheral is equipped with a secured BIOS ROM, the BIOS holds the key to opening the host protected space. Once the machine is initialized and the host protected space created, only the BIOS can expose it.

The host protected area (HPA) is a protected area of the hard drive reserved for storage of critical data and applications in a container segregated from the rest of the hardware by an internal firewall. This protected storage area is accomplished through the use of an ATA command called SETMAX. Issuing a SETMAX command to the hard drive allows the drive to report to the rest of the system that its maximum storage address (reported max) is lower than its actual physical storage limit (native max).

In an embodiment, the host protected space contains an intermediate bootable service and root certificate, a private key encrypted secure boot loader, a gaming CA signed encrypted site secret, an encrypted site private key, and a gaming certificate.

The intermediate bootable service is responsible for validating the root certificate by verifying its expiration date and extracting the public key from the root certificate. It then verifies the digitally authenticated compressed secure loader using the gaming CA public key. The gaming CA's public key is extracted from the gaming CA's certificate that is also verified by the root certificate. The decrypted compressed (optional) secure loader is decompressed (optional) and loaded into RAM for execution.

The secure loader is a program that loads the operating system, SQL server, and gaming server(s) or service(s) into RAM from the unprotected hard drive space. The secure loader first searches for a gaming CA signed encrypted site secret, verifies the gaming CA's digital signature on the encrypted site secret, and optionally prompts the site manager to type in the boot password to decrypt the site secret. If the site manager types in the proper boot password for the encrypted site secret, the secure loader uses the decrypted site secret to decrypt the 3DES encrypted operating system, SQL server, and gaming server(s) and service(s) from the unprotected hard drive space. It then loads them into system RAM for their execution. The secure loader also has an embedded list of authentic executables and deletes any executables that are not part of the list of authentic executables from the unprotected hard drive space.

If the secure loader fails to find gaming CA 12's signed encrypted site secret or if the user fails to submit the correct password after certain number of trials, the secure loader then looks for a private key encrypted installation executable within the unprotected hard drive space.

If the private key encrypted installation executable is successfully authenticated, the secure loader then executes the file, and generates a new user CA private/public key pair, and a certificate request for the newly generated user CA public key. The technician sends the certificate request to gaming RA 14, which validates the certificate request and forwards the certificate request to gaming CA 12.

In an embodiment, the unprotected area within the hard drive contains a private key encrypted installation executable, 3DES encrypted embedded operating system, 3DES encrypted SQL server, 3DES encrypted WIN Server, 3DES encrypted POS station, and a partitioned gaming data drive. The unprotected hard drive space is partitioned to store only gaming data and security log files to ensure continuous gaming even after accidental rebooting of the gaming system. The operating system ensures that no executables are stored in the partitioned gaming data drive and no executables are executed from the partitioned gaming data drive. The authenticity of the content of the partitioned gaming data drive is verified by the security loader during the boot up process by verifying that only certain files exist.

For a secure windows boot loader, the private key is encrypted in PKCS #5 format. The encrypted private key is stored in the host protected area. The executable uses the key to generate a certificate request for its newly generated public key.

The technician responsible for installing the software signs the certificate request using his private key. The certificate request is forwarded to the gaming RA for a secure Windows user CA boot loader. For other servers, services, devices, and peripherals, the certificate request is forwarded to user CA 17.

Gaming RA 14 validates the certificate request by verifying the digital signature of the technician and forwards the request to gaming CA 12. Gaming CA 12 issues a certificate for user CA 17's public key. A certificate is forwarded to the technician, used to find the 3DES key used to encrypt the OS, SQL Server, etc installed at site 15, and encrypt the 3DES key using the public key submitted for the gaming certificate. The encrypted 3DES key is then signed by gaming CA 12's private key.

User CA 17 analogously performs the same steps for other certificate requests.

The technician downloads the user CA gaming certificate and encrypted 3DES Key to his computer over a public network, stores the files on a disk, and inserts the disk into the server's disk drive or equivalent. The private key encrypted installation executable copies the encrypted 3DES key, verifies gaming CA 12's digital signature for the key for authentication, decrypts the encrypted key, and stores it in the host protected space as the site secret, by 3DES encrypting it using the same password used by the site manager for encrypting the site private key. The private key encrypted installation executable copies the gaming certificate for the site public key into the host protected area.

The boot password is a user-defined password that is used to encrypt the site secret and the Site Private Key for one implementation of the secure server based gambling system. Upon boot, the user must enter this password to start the boot sequence that uses the site secret and the site private key. Depending upon the jurisdiction, the process of entering a password may be automated.

In secured environments, all portable devices are authenticated. During a catalog, a program download or at the time of sale, the device provides its certificate to an installation station such as POS system 28. POS system 28 validates the certificate through the user CA and informs the device of its status. If the certificate is rejected or the device does not have a certificate, then it communicates to POS system 28 that it requires a certificate and provides some visible indicator that it needs to be authenticated before it can be used. The portable gaming unit then waits for a message from POS system 28. POS system 28 acknowledges when it is ready to validate the device. The device generates a public/private key pair and sends POS system 28 a certificate request. POS system 28 accumulates the various machine names and types and displays them for the technician to confirm. Once they are confirmed, POS system 28 requests certificates from the server for each device and sends the certificate to the device. The client then stores the certificate.

At the time of sale, POS system 28 wraps the session secret in the public key for the device. This prevents unauthorized devices on network 20 from decoding the session secret. The device can then use the session secret for receiving and sending broadcast messages.

While preferred embodiments of a method and apparatus for secure gaming support have been described and illustrated in detail, it is to be understood that numerous modifications can be made to embodiments of the present invention without departing from the spirit thereof.

What is claimed is:

1. A secure, server-based gambling system comprising:
a root digital certificate, the root digital certificate created by a trusted source and indicating authenticity of a server platform for a networked gambling system by authenticating software and data residing on the server platform;
a gaming certificate authority; and
a gaming registration authority;
wherein the gaming certificate authority includes the root certificate and is configured to issue digital certificates to the gaming registration authority, wherein the gaming registration authority is configured to receive certificate requests from clients, authenticate the requesting clients, and transmit certificate requests made by the authenticated clients to the gaming certificate authority, wherein the gaming registration authority is configured to receive digital certificates from the gaming certificate authority and transmit them to authenticated clients.

2. The system of claim 1, wherein the client comprises a user certificate authority.

3. The system of claim 1, wherein the client comprises a signing station.

4. The system of claim 1, wherein the client comprises a process that offers a user certificate as authentication of a user.

5. The system of claim 1, wherein the client comprises a device that offers a user certificate as authentication of a user.

6. The system of claim 1, wherein the root digital certificate comprises a public key and is stored on a computer-readable medium.

7. The system of claim 1, wherein the trusted source comprises a root certificate authority.

8. The system of claim 7, wherein the root certificate authority comprises a certified hardware security module configured to generate a public key and a private key.

9. The system of claim 8, wherein the certified hardware security module comprises a FIPS Level 3 hardware security module.

10. The system of claim 1, wherein the public key and private key are stored together in a token.

11. The system of claim 1, wherein the public key comprises a value calculated from data that is to be authenticated on a server.

12. The system of claim 11, wherein the calculated value comprises a hash value, the hash value resulting from application of a hashing function to the data that is to be authenticated on the server.

13. The system of claim 11, wherein the calculated value is encrypted.

14. The system of claim 1, wherein the system comprises an authentication module, the authentication module configured to compare a first value associated with data to be authenticated with a second value associated with the private key.

15. The system of claim 1, further comprising a firewall, the firewall separating the gaming certificate authority from the gaming registration authority.

16. The system of claim 1, further comprising a portable storage medium containing authentication data, the authentication data compared against data read from a server.

17. The system of claim 16, wherein the authentication data matches data associated with server.

18. The system of claim 16, wherein the authentication data comprises a calculated value.

19. The system of claim 13, wherein the calculated value comprises a result of a hashing function applied to a collection of data.

20. The system of claim 19, wherein the collection of data comprises software instructions that are executed on a client device.

21. The system of claim 16, wherein the authentication data is encrypted.

22. The system of claim 16, wherein the portable storage medium comprises a magnetic storage medium.

23. The system of claim 16, wherein the portable storage medium comprises optical storage medium.

24. The system of claim 16, wherein the portable storage medium comprises a read-only storage medium.

25. The system of claim 16, wherein the portable storage medium comprises software instructions for authenticating data on the server.

26. The system of claim 16, wherein the portable storage medium further comprises data to be loaded on a client device.

27. The system of claim 26, wherein the data to be loaded on the server comprises software instructions to be executed by the server.

28. A method of operating a server-based gambling system, comprising:
issuing a root digital certificate from a trusted source to a gaming certificate server;
authenticating a gaming certificate server by examining a public key associated with the gaming certificate server and generating a second digital certificate indicating that the gaming certificate server is authentic, the second digital certificate containing data indicating the root digital certificate;
the gaming certificate authenticating a gaming registration server by generating a third digital certificate, the third user certificate containing data indicating the second digital certificate; and
transmitting and receiving data sets and key values to and from clients authenticated by the gaming registration server.

29. The method of claim 28, wherein the public key comprises a first calculated value, wherein authenticating a gaming certificate server comprises deriving a second calculated value and comparing it to the first calculated value.

30. The method of claim 28, further comprising transferring the root digital certificate from the trusted source to the gaming certificate server by way of a portable storage device.

31. The method of claim 28, wherein authenticating a gaming server comprises comparing a first value associated with the public key to a second value associated with data associated with the gaming certificate server.

32. The method of claim 31, wherein the first value comprises a hash value, the hash value resulting from a hash function applied to data that is to be authenticated, the data to be authenticated also associated with the gaming certificate server.

33. The method of claim 28, wherein authenticating a gaming registration server comprises comparing a first value associated with the public key to a second value associated with data associated with the gaming registration server.

34. The method of claim 33, wherein the first value comprises a hash value, the hash value resulting from a hash function applied to data that is to be authenticated, the data to be authenticated also associated with the gaming registration server.

35. A secure, server-based gambling system comprising:
a root digital certificate, the root digital certificate created by a trusted source and indicating authenticity of a server platform for a networked gambling system by authenticating software and data residing on the server platform; and
a gaming server, wherein the gaming server includes the root certificate and is configured to receive certificate requests from clients, authenticate the requesting clients, and issue digital certificates and transmit them to authenticated requesting clients.

36. The system of claim 35, wherein the client comprises a user certificate authority.

37. The system of claim 35, wherein the client comprises a signing station.

38. The system of claim 35, wherein the client comprises a process that offers a user certificate as authentication of a user.

39. The system of claim 35, wherein the client comprises a device that offers a user certificate as authentication of a user.

40. The system of claim 35, wherein the root digital certificate comprises a public key and is stored on a computer-readable medium.

41. The system of claim 35, wherein the trusted source comprises a root certificate authority.

42. The system of claim 41, wherein the root certificate authority comprises a certified hardware security module configured to generate a public key and a private key.

43. The system of claim 42, wherein the certified hardware security module comprises a FIPS Level 3 hardware security module.

44. The system of claim 35, wherein the public key and private key are stored together in a token.

45. The system of claim 35, wherein the public key comprises a value calculated from data that is to be authenticated on a server.

46. The system of claim 45, wherein the calculated value comprises a hash value, the hash value resulting from application of a hashing function to the data that is to be authenticated on the server.

47. The system of claim 45, wherein the calculated value is encrypted.

48. The system of claim 35, wherein the system comprises an authentication module, the authentication module configured to compare a first value associated with data to be authenticated with a second value associated with the private key.

49. The system of claim 35, further comprising a firewall, the firewall separating the gaming certificate authority from the gaming registration authority.

50. The system of claim 35, further comprising a portable storage medium containing authentication data, the authentication data compared against data read from a server.

51. The system of claim 50, wherein the authentication data matches data associated with server.

52. The system of claim 50, wherein the authentication data comprises a calculated value.

53. The system of claim 48, wherein the calculated value comprises a result of a hashing function applied to a collection of data.

54. The system of claim 54, wherein the collection of data comprises software instructions that are executed on a client device.

55. The system of claim 51, wherein the authentication data is encrypted.

56. The system of claim 51, wherein the portable storage medium comprises a magnetic storage medium.

57. The system of claim 51, wherein the portable storage medium comprises optical storage medium.

58. The system of claim 51, wherein the portable storage medium comprises a read-only storage medium.

59. The system of claim 51, wherein the portable storage medium comprises software instructions for authenticating data on the server.

60. The system of claim 51, wherein the portable storage medium further comprises data to be loaded on a client device.

61. The system of claim 60, wherein the data to be loaded on the server comprises software instructions to be executed by the server.

62. A method of operating a server-based gambling system, comprising:
issuing a root digital certificate from a trusted source to a gaming certificate server;
authenticating a gaming certificate server by examining a public key associated with the gaming certificate server and generating a second digital certificate indicating that the gaming certificate server is authentic, the second digital certificate containing data indicating the root digital certificate; and
transmitting and receiving data sets and key values to and from clients authenticated by the gaming certificate server.

63. The method of claim 62, wherein the public key comprises a first calculated value, wherein authenticating a gaming certificate server comprises deriving a second calculated value and comparing it to the first calculated value.

64. The method of claim 62, further comprising transferring the root digital certificate from the trusted source to the gaming certificate server by way of a portable storage device.

65. The method of claim 62, wherein authenticating a gaming certificate server comprises comparing a first value associated with the public key to a second value associated with data associated with the gaming certificate server.

66. The method of claim 65, wherein the first value comprises a hash value, the hash value resulting from a hash function applied to data that is to be authenticated, the data to be authenticated also associated with the gaming certificate server.

67. A computer-readable medium containing instructions which, when executed by a computer, operate a server-based gambling system, by:
issuing a root digital certificate from a trusted source to a gaming certificate server;
authenticating a gaming certificate server by examining a public key associated with the gaming certificate server and generating a second digital certificate indicating that the gaming certificate server is authentic, the second digital certificate containing data indicating the root digital certificate;
the gaming certificate authenticating a gaming registration server by generating a third digital certificate, the third user certificate containing data indicating the second digital certificate; and
transmitting and receiving data sets and key values to and from clients authenticated by the gaming registration server.

68. A computer-readable medium containing instructions which, when executed by a computer, operate a server-based gambling system, by:
issuing a root digital certificate from a trusted source to a gaming certificate server;
authenticating a gaming certificate server by examining a public key associated with the gaming certificate server and generating a second digital certificate indicating that the gaming certificate server is authentic, the second digital certificate containing data indicating the root digital certificate; and
transmitting and receiving data sets and key values to and from clients authenticated by the gaming certificate server.
